(19) United States
(12) Patent Application Publication
(10) Pub. No.: US 2004/0233424 A1
(43) Pub. Date: Nov. 25, 2004

(54) Chip-based microfluidic particle detector with three dimensional focusing mechanisms

(75) Inventors: Gwo-Bin Lee, Tainan City (TW); Che-Hsin Lin, Kaohsiung (TW)

Correspondence Address: BACON & THOMAS, PLLC, 625 SLATERS LANE, FOURTH FLOOR, ALEXANDRIA, VA, 22314

(73) Assignee: National Cheng Kung University, Tainan City (TW)

(21) Appl. No.: 10/840,255

(22) Filed: May 7, 2004

(30) Foreign Application Priority Data
May 21, 2003 (TW) 92113698

(51) Int. Cl. G01N 1/10

(52) U.S. Cl. 356/246

(57) ABSTRACT

The present invention relates to a chip-based device for three-dimensional microfluidic particle focusing and detection, characterized in which through the actions of fluidic driving force and dielectrophoretic forces, microparticles flow in the center of microchannels which enhances the accuracy of subsequent detection. The chip of the present invention is fabricated by first creating microchannels on a substrate for fluid flow, including specimen channels and sheath fluid channels, carrying out two-dimensional fluid focusing on particles in the sample flow, and fabricating microelectrodes in the microchannels to provide dielectrophoretic forces for three-dimensional focusing of particles. The present invention is applicable to the counting, determination, speed measuring and sorting of all kinds of microparticles, such as cells and blood cells.

### BACKGROUND OF THE INVENTION

1. Field of the Invention

The present invention provides a three-dimensional microfluidic particle focusing method, using the actions of fluidic driving force and dielectrophoretic force to enable microparticles to flow in the center of the microchannels, hence enhancing the accuracy of subsequent detection.

2. Description of the Related Art

The development of Micro-electro-mechanical-system (MEMS) technology has made the fabrication of miniature components possible. Aside from offering the advantages of light, thin, short and tiny, miniaturization greatly enhances the assay efficiency and speed. In a wide range of MEMS research fields, the application of micro components in biomedical assay is given the greatest attention. Microfluidic biochips produced by MEMS technology feature high assay throughput, low sample consumption, low energy consumption, small size, and low cost. The design of integrating microfluidic system and detection mechanism on the same chip has great development potential and market value in particular. Besides being tiny in size, a biochip possesses complete assay functions without the use of complicated and expensive testing equipment.

Flow cytometer has been applied extensively in biomedical assay for counting and sorting of cells providing an important reference in clinical diagnosis. Conventional flow cytometers are bulky, expensive and highly complicated, hence unsuitable for micro-fabrication into portable devices. This patent applicant discloses an invention of micro particle/cell counter using MEMS technology in TW Patent No.504491, which carries out two-dimensional focusing of fluidic particles by means of sheath flow. This invention integrates optical detection mechanism in cytometer, which not only greatly reduces the size of the detection system, but also provides low-cost, high-precision measurement without the complicated fluorescent labeling procedure or complicated and expensive optical alignment mechanism and procedure. However the device does have the problem of inconsistent signal strength. This is because the micro chips fabricated using MEMS technology mostly have planar structure, which provides good 2D focusing on particles/cells in the microchannels, but gives microparticles in the direction of the third axis certain freedom, allowing them to distribute freely along the Z direction of microchannels. Consequently, microparticles are located at different height along the Z direction when passing through the detection area, resulting in inconsistent signals detected.

The control of microparticles through dielectrophoretic force has been revealed in many papers and patents (e.g. US Patient No. 6,287,832 B1) and is a mature technology. But in the control of microparticles by dielectrophoretic force, the majority devices use planar electrode array, which does not effectively control the vertical distance of microparticles from the electrodes. Instead, this invention used vertically-aligned electrodes to focus microparticles in vertical direction.

### SUMMARY OF THE INVENTION

To address the drawbacks of prior arts for fabrication of micro-scale components using MEMS technology, the present invention provides a three-dimensional microfluidic particle focusing and detecting device to obtain uniform signal strength.

This invention features the addition of a third dimension focusing device to the fluidic focusing mechanism for 3D microparticle focusing, which is achieved by introducing alternating current through the microelectrodes arranged in the chip channel, hence subjecting the microparticles flown in the channels to dielectrophoretic force induced by the AC field in addition to the focusing action. It also utilizes the negative dielectrophoretic force (repulsion force) experienced by the microparticles from the electrodes in the channel, which pushes the particles into the center of inter-electrode space to achieve the objective of third dimension focusing.

One object of the present invention is to provide a chip-based device for three-dimensional microfluidic particle focusing, comprising: a fluidic driving unit for driving fluid; a chip with microfluidic channels, detection structure and microelectrodes integrated thereon; a signal generating unit to provide alternating current signals for said microelectrode to produce dielectrophoretic force; a signal receiving unit; and a signal processing unit to process signals from said signal receiving unit.

The fluidic driving unit includes pump or DC drive power supply.

The microfluidic channels include sample microchannels and sheath fluid microchannels.

The microelectrodes are made of gold, cooper, titanium, chromium, aluminum or conducting material having similar functions in comb, interdigited, or planar design.

The signal generating unit is a signal generating unit with functions of producing various frequency, voltage, sine wave, triangular wave, square wave or other similar functions.

The detection structure can be optical detection structure or electrical signal measuring structure. The optical detection structure integrated on the chip consists of at least a pair of optic fiber trenches and optical fibers. In case of optical detection, the device according to this invention further includes: a light source to provide light to said fiber optic structure; and a photo detector as signal receiving unit to receive signals detected by the optical fibers.

The electrical signal measuring structure consists of metal conducting wires inserted directly into the fiber optic trenches, replacing the optical fibers used in optical measurement to measure directly electrical signals including capacitance, resistance, and impedance.

The light source can be any light emitting unit, such as laser (visible or invisible light), mercury lamp or LED.

The signal receiving unit can further co-operate with a signal amplifier to magnify the signals received and enhance the detection sensitivity.

The signal processing unit includes an analog/digital signal converter and a computer. The computer controls the aforementioned fluidic driving unit to regulate the output rate of sample flow and sheath flows. Another object of the present invention is to provide a chip having the functions of microfluidic particle focusing and detection, comprising: at least a sample microchannel to guide the sample flow; at least two sheath fluid microchannels to guide the sheath flows; at least a pair of vertically parallel electrodes for operating dielectrophoretic focusing in Z direction; and at least a pair of detection structures for detecting sample signals.

The detection structure can be optical detection structure or electrical signal measuring structure. The optical detection structure integrated on the chip consists of at least a pair of optic fiber trenches and optical fibers. In case of optical detection, the device according to this invention further includes: a light source to provide light to said fiber optic structure; and a photo detector as signal receiving unit to receive signals collected by the optical fibers.

The electrical signal measuring structure consists of metal conducting wires inserted directly into the fiber optic trenches, replacing the optical fibers used in optical measurement to measure directly electrical signals including capacitance, resistance, and impedance.

The method of integrating an optical detection structure on the chip comprises the following steps: providing a chip substrate; etching fiber optic trenches on said substrate; combining two chip substrates having identical fiber optic trenches; and inserting etched optical fibers into said trenches to carry out optical detection.

The chip substrate is made of glass, silicon wafer, or polymer; said polymer material includes poly(methyl methacrylate) (PMMA), polycarbonate (PC), polystyrene (PS), acrylonitrile butadiene styrene (ABS), Poly(dimethylsiloxane) (PDMS) or other polymers.

Yet another object of the present invention is to provide a method for three-dimensional microfluidic particle focusing and detection, comprising the following steps: carrying out two-dimensional focusing of microfluidic particles through sheath flows generated in the sheath fluid channels on the chip; carrying out three-dimensional focusing of microfluidic particles through the dielectrophoretic forces produced by embedded microelectrodes on the chip; and finally, carrying out real-time detection through the detection structure integrated on the chip.

The present invention first carries out two-dimensional fluid focusing of microparticles, then passing through the parallel electrode zone integrated on the chip where the particles are exposed to negative dielectrophoretic forces derived from induced dipole moment of the alternating current field that pushes the particles to the center of inter-electrode space to achieve the objective of third-dimension dielectrophoretic focusing. The method for detecting microparticles (e.g. cells, blood cells, etc) of the present invention can be optical detection or electrical signal detection.) by optical or electrical means. The optical detection utilizes optical fibers integrated on the chip for detecting optically, resolving the problem of alignment and connection between the fiber optic structures and the chip. The fiber optic structures are disposed in the fiber optic trenches made in standard photolithographic and developing procedures, allowing light to come in and out of the chip without using sophisticated alignment procedures and expensive hardware. In electrical signal detection, the optical fibers in the fiber optic trenches are replaced with metal wires without the need for light source to achieve the same detection purpose. Through the two detection modes described above and the three-dimensional fluid focusing method according to this invention, a simple chip-based three-dimensional microfluidic particle focusing and detecting device that performs instant online detection is obtained, which can not only rapidly and effectively detect all kinds of microparticles but also differentiate microparticles of different sizes, thus providing a powerful detection tool in medical and industrial applications.

### BRIEF DESCRIPTION OF THE DRAWINGS

FIG. 1 shows the schematic diagram of the chip-based device for three-dimensional microfluidic particles focusing and detection by optical means according to the present invention.

FIG. 2A shows the schematic diagram of the chip structure of the present invention.

FIG. 2B shows the side-view diagram of dielectrophoretic focusing according to the present invention.

FIG. 2C shows the side-view diagram of particles passing through the center of the detection zone after three-dimensional focusing.

FIG. 3 shows the schematic diagram of the chip fabrication process according to the present invention.

FIG. 4A is a magnified image of the fluidic focusing member on the chip fabricated according to the present invention.

FIG. 4B is the magnified image of the fiber optic detection member on the chip fabricated according to the present invention.

FIG. 5 shows the image of electrodes on the chip for generation of dielectrophoretic force.

FIG. 6 shows the image of the three-dimensional microparticle focusing and detecting chip fabricated according to the present invention.

FIG. 7 shows continuous images showing two-dimensional focusing of microfluidic particles by the device according to the present invention.

FIG. 8A shows the detection results after two-dimensional focusing of microfluidic particles in Example 1 of the present invention.

FIG. 8B shows the detection results after three-dimensional focusing of microfluidic particles in Example 1 of the present invention.

FIG. 9A is the theoretical diagram of fluid focusing using electrical driving force in Example 2 of the present invention.

FIG. 9B is the result of fluid focusing using DC electrical driving force in Example 2 of the present invention.

FIG. 10 shows the graph of signal strength vs. particle size obtained in Example 3 of the present invention.

### DETAILED DESCRIPTION OF THE INVENTION

The advantages and features of the chip-based device for three-dimensional microfluidic particle focusing and detection according to this invention and its fabrication are further explained with accompanying diagrams.

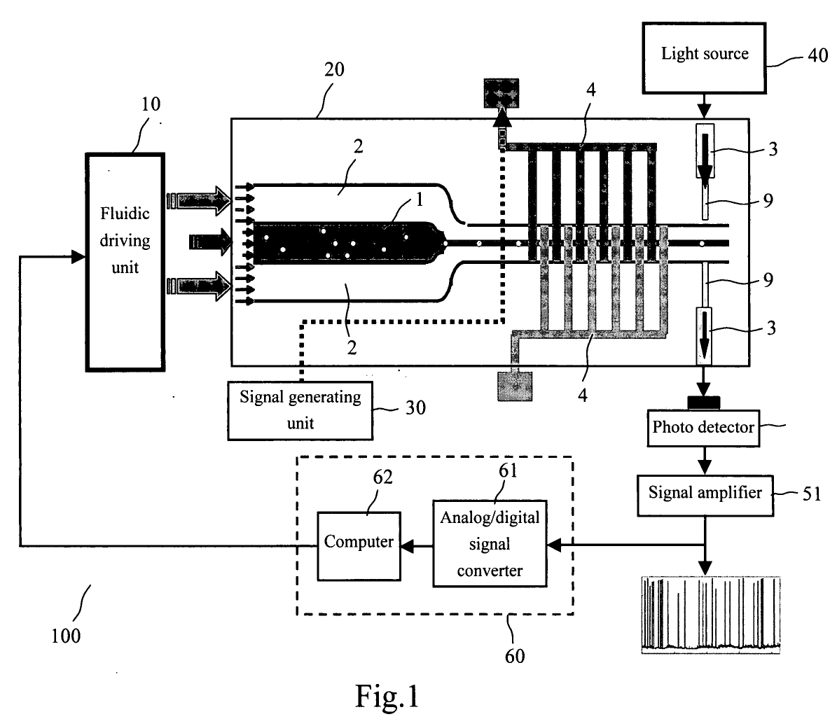

The chip-based device for three-dimensional microfluidic particle focusing and detection 100 in the first embodiment of the invention (detection by optical means) as shown in FIG. 1 comprises: a fluidic driving unit 10 for fluid drive; a chip 20 integrating microfluidic channels 1 & 2, fiber optic structure including a pair of fiber optic trenches 3 and a pair of optical fibers 9 inserted into said fiber optic trenches 3, and microelectrodes 4 thereon; a signal generating unit 30 to provide alternating current signals for said microelectrodes 4 to produce dielectrophoretic force; a light source 40 to provide light to said optical fibers 9; a photo detector 50, and a signal processing unit 60 to process signals from said photo detector 50.

The photo detector 50 may further magnify the detected signals through a signal amplifier 51 to enhance the detection sensitivity.

The signal processing unit 60 includes: an analog/digital signal converter 61 and a computer 62. The computer 62 can control the above-mentioned fluidic driving unit 10 to regulate the output rate of sample flow and sheath flow and to retrieve and analyze the detected signals transmitted from the signal amplifier 51. The fluidic driving unit 10 includes pump or DC drive power supply.

The second embodiment of this invention switches the fiber optic detection to electrical signal detection using the same apparatus as that in FIG. 1, whereas only the optical fibers are replaced with metal wires by inserting a pair of metal wires directly into the fiber optic trenches 3 to measure directly electrical signals, including capacitance, resistance and impedance without the use of light source 40 and photo detector 50.

The features of the invention are illustrated by the following example of fiber optic detection.

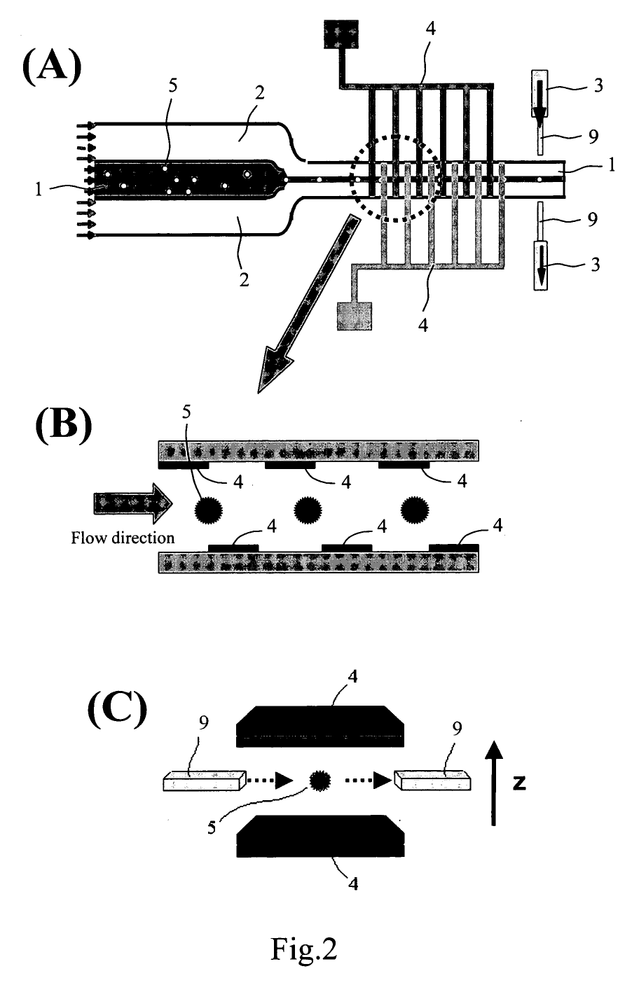

As shown in FIG. 2A, the chip of the invention is used primarily for three-dimensional focusing and detection of microfluidic particles, comprising at least a sample microchannel 1 to guide the sample flow; at last two sheath fluid microchannels 2 (preferably two or more) to guide the sheath flows; at least a pair of vertically parallel electrodes 4 for dielectrophoretic focusing; and at least a pair of mutually aligned optical fibers 9 for light transmission.

The focusing method of the invention combines fluidic force and dielectrophoretic force to achieve three-dimensional focusing. The first part is the two-dimensional focusing, in which sample flow is introduced into the sample microchannel 1 where the two-dimensional focusing of microparticles 5 in the sample flow is carried out through the sheath flows generated from the sheath fluid microchannels 2 on both sides; the microparticles 5 in the sample flow are then pushed to the center of the microchannel and advance in order. The second part is the third-dimension dielectrophoretic focusing. As shown in FIG. 2B, the vertically parallel electrodes 4 produce negative dielectrophoretic forces to repel the microparticles 5 in the microchannel to the center of two electrodes 4 to achieve third-dimension focusing. The microparticles 5 (e.g. cells or other microparticles) that have had 3D focusing flow along the center of microchannels and pass the detection area with precision where optical fibers 9 carry out instant online detection to achieve better detection results as shown in FIG. 2C.

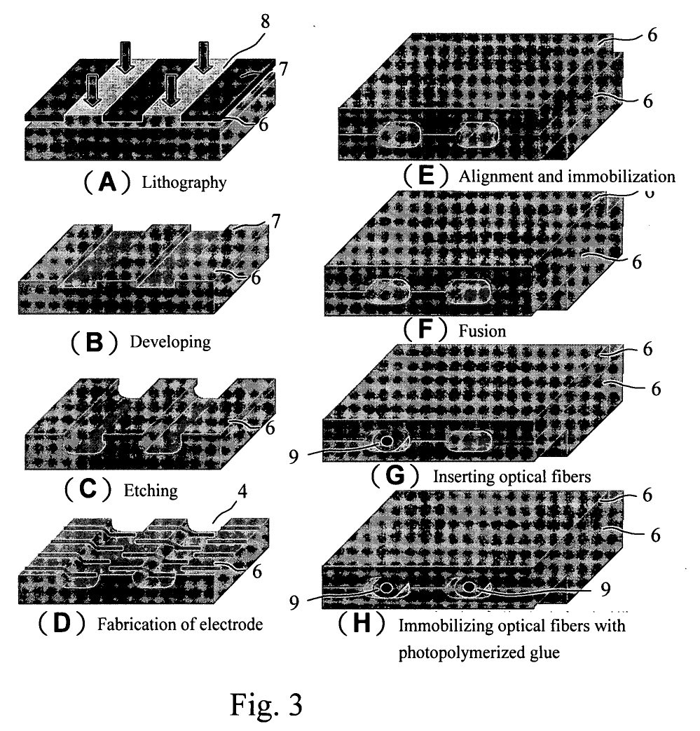

The process for fabricating the chip having the function of three-dimensional particle focusing and detection according to the invention is described in detail along with the diagrams shown in FIG. 3A˜3H.

The fabrication method comprises mainly the following steps: As shown in FIG. 3A, coat a photoresist (PR) layer 7 (e.g. AZ4620) on a chip substrate 6 and carry out lithography with a designed photomask 8; as shown in FIG. 3B, carry out PR developing; as shown in FIG. 3C, carry out etching to etch the chip substrate 6 to the predetermined width and depth (e.g. 70 μm wide, 25 μm deep); as shown in FIG. 3D, fabricate electrodes 4 for dielectrophoretic focusing which involves the procedure of vacuum plating metal conducting layer (e.g. Cr/Au) on the etched and PR stripped chip substrate 6 and then defining the electrode pattern; next as shown in FIG. 3E, align two identical chip substrates having the same symmetrical channels and electrodes fabricated according to the steps in 3A˜3D and glue them together with photopolymerized glue; as shown in FIG. 3F, place the chip substrates 6 obtained in FIG. 3E in a high-temperature oven filled with inert gas (e.g. nitrogen) to fuse the two substrates; next as shown in FIG. 3G, etch the optical fibers 9 with chemical (e.g. buffer solution made of hydrofluoric acid and ammonium fluoride) to reduce their diameter, and insert the etched optical fibers 9 into the etched microchannels on the substrate; finally as shown in FIG. 3H, immobilize the optical fibers with photopolymerized glue to complete the chip fabrication.

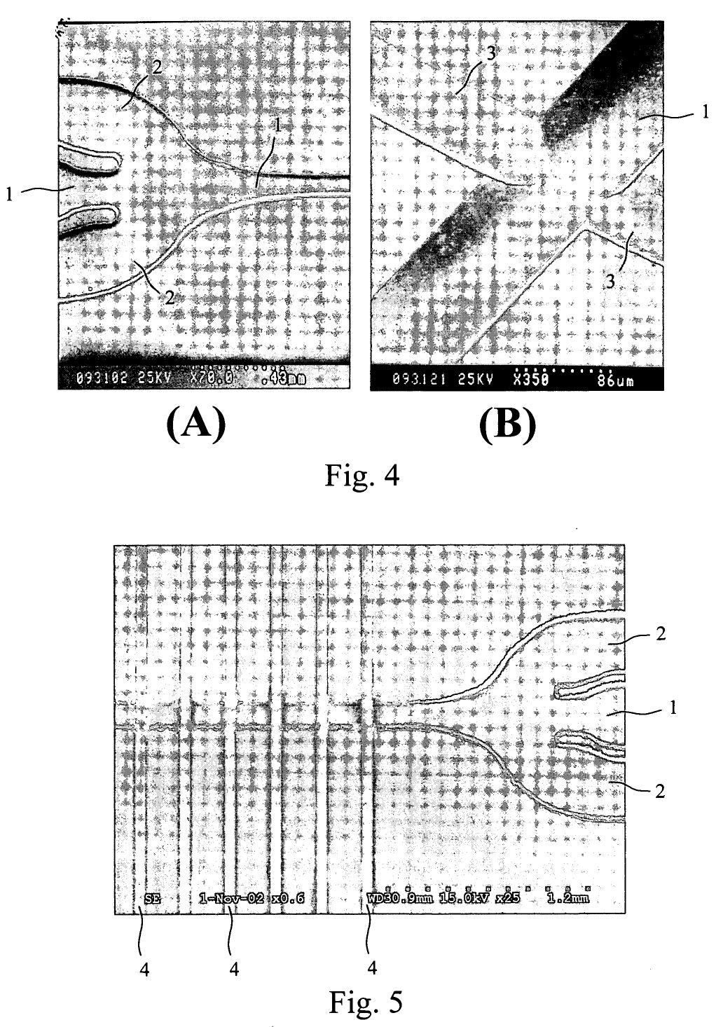

FIG. 4A shows the magnified image of the fluid focusing member on the chip fabricated according to the invention, which comprises sample microchannel 1 and sheath fluid microchannels 2. FIG. 4B shows the magnified image of the fiber optic trenches 3 on the chip fabricated according to the invention. As shown in those figures, the microchannels produced with the process technology provided in the invention have high precision and leveled surface, hence suitable for fluidic operation. FIG. 5 shows the comb-shaped dielectrophoretic electrodes 4, which are made of chromium and gold; the chromium is used as adhesive layer to enhance the adhesion of gold, and gold is used as a conducting layer. The microelectrodes 4 can be made of gold, cooper, titanium, chromium, aluminum or conducting material having similar functions in comb, interdigited, or planar design.

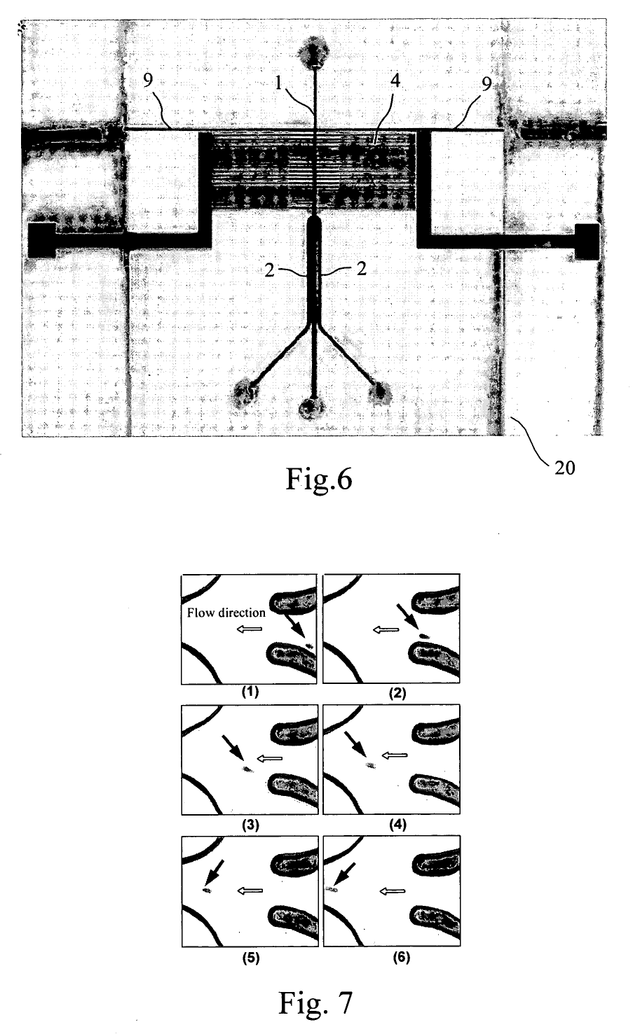

FIG. 6 shows the image of the three-dimensional microparticle focusing and detecting chip 20 fabricated according to the invention. Said chip has a pair of optical fibers 9 for optical detection, and 40 pairs of dielectrophoretic electrodes lined up vertically on the substrate, and may be used for three-dimensional particle focusing as well as counting and detection.

Examples are illustrated below to depict the results of using the invention for three-dimensional particle focusing and detection.

### EXAMPLE 1

In this example, device 100 as shown in FIG. 1 is used. First introduce respectively the sample flow and sheath flows into the sample microchannel 1 and sheath fluid microchannels 2 on chip 20 through fluidic driving unit 10, and then focus the sample flow to a certain width, for example, the width of one cell, by controlling the rates of sheath flows and sample flow, and the microparticles in the sample flow were focused and flowed in order to complete the two-dimensional focusing; subsequently use a signal generating unit 30 to produce AC field in the electrodes 4, which would generate induced dipole moments on the microparticles passing through, which were then exposed to the negative dielectrophoretic forces generated and repelled to the center of two vertically arranged electrodes 4 to complete the third-dimension focusing. After the three-dimensional focusing, the microparticles were converged at the downstream fiber optic detection area; the light from light source 40 entered from the inlet of optical fibers 9 and passed through the sample flow. At this time, the microparticles in the sample flow would absorb or scatter the light to lead to change of light intensity. The aforesaid light would exit from the outlet of the optical fiber 9 at the other end where photo detector 50 was used to detect the change of light intensity; the optical signals may be magnified using a signal amplifier 50 before they were transmitted to the signal processing unit 60 for detection.

The aforesaid fluidic driving unit 10 was a syringe pump or DC voltage source to regulate the fluid flow.

As shown in FIG. 7 which are continuous images showing two-dimensional focusing of microfluidic particles by the device according to the present invention, the 20 μm microparticles (indicated by dark arrow) were focused by the sheath flow on both sides and flowed into the center of microchannel after exiting the sample flow nozzle. Thus the fluid focusing method provided in the invention is found to be effective in two-dimensional focusing of microparticles in the channel.

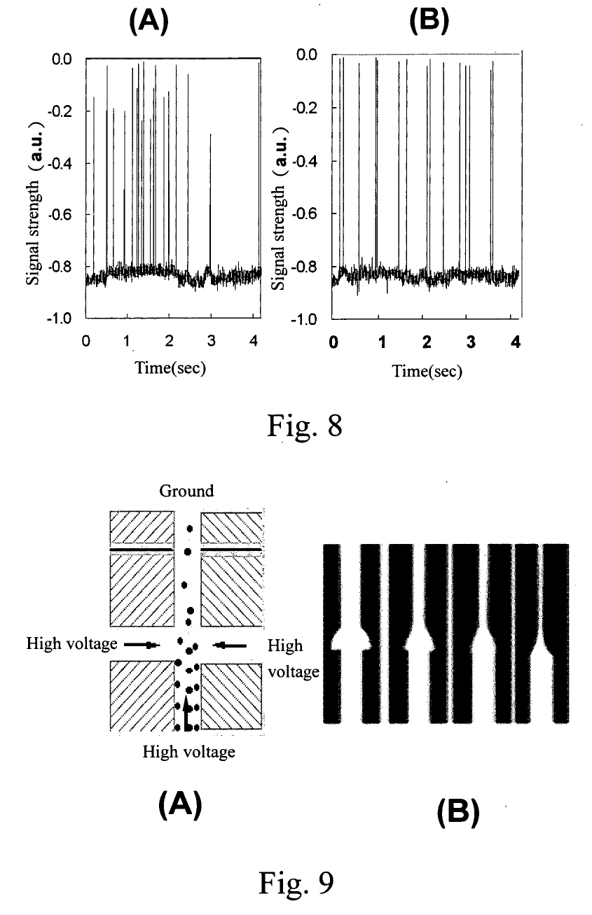

FIG. 8 shows the result of microfluidic particle detection using the chip-based device according to the invention. The microparticles used were 20 μm polystyrene particles, and the fluid carrying those microparticles is a buffer solution with conductivity adjusted to 2.0 mS/cm by adding salts to deionized water to facilitate dielectrophoretic focusing. FIG. 8A is the signal intensity graph obtained in the absence of dielectrophoretic focusing. As shown, the two-dimensionally focused microparticles were freely distributed within the degree of freedom given, hence producing less uniform signal strength. FIG. 8B is the signal intensity graph obtained in the presence of third-dimension focusing. As shown, the signals of particles were more uniform after the introduction of dielectrophoretic forces. The results demonstrate that the combination of fluidic driving force for two-dimensional focusing and dielectrophoretic forces for third-dimension focusing can effectively converge microparticles to the center of the channel before passing the detection area.

### EXAMPLE 2

As mentioned earlier, besides using syringe pump to provide fluidic driving force, this invention can also use high-voltage DC power supply to provide the driving force by means of electroosmosis flow. The driving theory is as shown in FIG. 9A. In this example, sample flow containing cellular particles was introduced into the sample microchannel and a high-voltage field was provided for electroosmosis drive. High-voltage driving fluid was also provided to the side channels for sheath flow to compress the width of sample flow in the middle. The microparticles were then detected using the same optical or electrical detection method at downstream. FIG. 9B shows the images of focusing results obtained under different driving voltage for sample flow and sheath flow. The fluid used in the sample was sodium borate (Na₂B₄O₇.10H₂O), with pH adjusted to 9.2. The center sample flow solution was 10⁻⁴M Rhodamine B fluorescent dye. The chip was mounted under the fluorescent detection system and camera was used to capture the fluorescent images. As shown in the FIG. 9B, the desired focusing result can be achieved through proper control of the driving voltage for sample flow and sheath flows. This example demonstrates that the chip according to this invention can carry out fluid focusing using high voltage.

### EXAMPLE 3

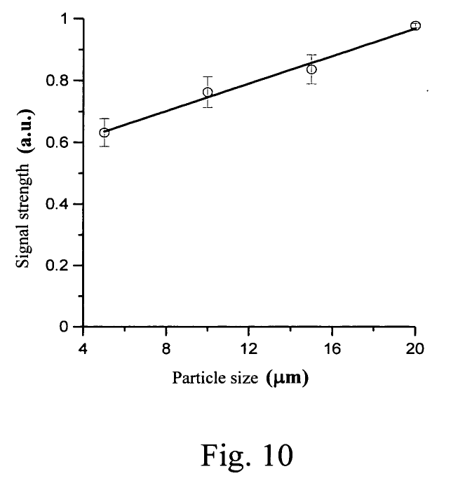

This example used the same device in Example 1, and polystyrene particles of different sizes were used for the testing to demonstrate that the device according to the invention can differentiate microparticles of varying sizes without fluorescent labeling. The sizes of particles used for the testing were 5, 10, 15 and 20 μm. The test results are as shown in FIG. 10. The sizes of particles were differentiated based on the fact that particles of different sizes have different light blocking or scattering abilities. The experimental results show that microparticles of different sizes produced different signal strength. Thus in addition to carrying out three-dimensional focusing of microfluidic particles in the sample to enhance the stability of produced signals, the device according to the invention can also differentiate microparticles of different sizes without labeling the samples by fluorescence or other methods.

To sum up, the present invention provides a three-dimensional microfluidic particle focusing/detecting method and device that offer the following advantages: 1. The invention provides a chip for three-dimensional focusing of microparticles with an innovative approach by combining the fluid focusing and dielectrophoretic focusing effects in the microfluidic system; 2. The design and process of the invention are simple, reliable, and able to fabricate microfluidic chip with three-dimensional focusing function rapidly at low cost, and such chips may be applied in biological and industrial testing and analysis; 3. The device in the invention can integrate the testing and control systems with the aid of computer and design channels and electrodes having different functions to carry out instant testing, sorting and collection; and 4. The chip in this invention is easily integrated with microfluidic chip of different functions to create an integrated microfluidic platform based on different experimental needs. Therefore, the present invention may be extensively applied in biochemical assay, medical detection and industrial testing.

What is claimed is:

1. A chip-based device for three-dimensional focusing of microfluidic particles, comprising:
a fluidic driving unit for driving the fluid;
a chip having microfluidic channels, detection structure and microelectrodes integrated thereon;
a signal generating unit to provide alternating current signals for said microelectrodes to produce dielectrophoretic force;
a signal receiving unit; and
a signal processing unit to process signals from said signal receiving unit.

2. The device according to claim 1, wherein said fluidic driving unit includes pump or DC drive power supply.

3. The device according to claim 1, wherein said detection structure is optical detection structure or electrical signal measuring structure.

4. The device according to claim 3, wherein said optical detection structure includes at least a pair of fiber optic trenches and a pair of optical fibers integrated on said chip.

5. The device according to claim 4, wherein said device further includes a light source to provide light to said optical fibers and a photo detector as a signal receiving unit for receiving signals detected by said optical fibers.

6. The device according to claim 3, wherein said electrical signal measuring structure consists of metal conducting wires directly inserted into the fiber optic trenches.

7. The device according to claim 1, wherein said microfluidic channels include sample microchannels and sheath fluid mcirochannels.

8. The device according to claim 1, wherein said microelectrodes are made of gold, cooper, titanium, chromium, aluminum or other conducting materials.

9. The device according to claim 1, wherein said microelectrodes are in comb, interdigited or planar design.

10. The device according to claim 1, wherein said chip is made of glass, siliconwafer or polymer.

11. The device according to claim 10, wherein said polymer material includes poly(methyl methacrylate) (PMMA), polycarbonate (PC), polystyrene (PS), acrylonitrile butadiene styrene (ABS), Poly(dimethylsiloxane) (PDMS) or other polymers.

12. The device according to claim 1, wherein said signal generating unit can produce frequency, voltage, sine wave, triangular wave, square wave or other signals.

13. The device according to claim 5, wherein said light source includes laser, mercury lamp or LED.

14. The device accordin to claim 1, wherein said signal receiving unit can further co-operate with a signal amplifier to magnify the detected signals so as to increase the detection sensitivity.

15. The device according to claim 1, wherein said signal processing unit comprises an analog/digital signal converter and a computer.

16. The device according to claim 15, wherein said computer controls the fluidic driving unit to regulate the output rate of sample flow and sheath flows.

17. The device according to claim 1, wherein said particles include cells, blood cells or other microparticles.

18. A chip having the functions of microfluidic particle focusing and detection, comprising:
at least a sample microchannel to guide the sample flow;
at least two sheath fluid microchannels to guide the sheath flows;
at least a pair of vertically parallel electrodes for operating electrophoretic focusing; and
at least a pair of detection structures for detecting sample signals.

19. The chip according to claim 18, wherein said detection structure is optical detection structure or electrical signal measuring structure.

20. The chip according to claim 19, wherein said optical detection structure comprises at least a pair of fiber optic trenches and optical fibers integrated on the chip.

21. The chip according to claim 19, wherein said electrical signal measuring structure consists of metal conducting wires directly inserted into the fiber optic trenches.

22. The chip according to claim 19, wherein said optical detection structure is integrated on the chip by the steps of: providing a chip substrate; etching fiber optic trenches on said substrate; combining two chip substrates having identical fiber optic trenches; and inserting etched optical fibers into said trenches.

23. The chip according to claim 18, wherein said chip substrate is made of glass, silicon wafer or polymer.

24. The chip according to claim 23, wherein said polymer material includes poly(methyl methacrylate) (PMMA), polycarbonate (PC), polystyrene (PS), acrylonitrile butadiene styrene (ABS), Poly(dimethylsiloxane) (PDMS) or other polymers.

25. A method for three-dimensional microfluidic particle focusing and detection, comprising the steps of:
carrying out two-dimensional focusing of microfluidic particles through sheath flows generated in the sheath fluid channels on the chip;
carrying out three-dimensional focusing of microfluidic particles through the dielectrophoretic forces produced by microelectrodes on the chip; and
carrying out instant detection through the detection structure integrated on the chip.

26. The method according to claim 25, wherein said microelectrodes are made of gold, cooper, titanium, chromium, aluminum or other conducting materials.

27. The method according to claim 25, wherein said microelectrodes are in comb, interdigited or planar design.

28. The method according to claim 25, wherein said particles include cells, blood cells and other microparticles.

29. The method according to claim 25, wherein said step of two-dimensional focusing of microfluidic particles can be achieved through sheath flow driven by high-voltage to compress the width of sample flow in the middle.
